(19) United States
(12) Patent Application Publication
(10) Pub. No.: US 2017/0255896 A1
(43) Pub. Date: Sep. 7, 2017

(54) Unattended Delivery Drop Box

(71) Applicant: Jesse Van Dyke, Chicago, IL (US)

(72) Inventor: Jesse Van Dyke, Chicago, IL (US)

(21) Appl. No.: 15/088,266

(22) Filed: Apr. 1, 2016

Related U.S. Application Data
(63) Continuation-in-part of application No. 15/061,264, filed on Mar. 4, 2016.

(51) Int. Cl. G06Q 10/08; H04L 29/06; A47G 29/122; A47G 29/12; A47G 29/124; G08G 5/00; G05D 1/10

(52) U.S. Cl. CPC G06Q 10/083; G08G 5/0043; H04L 67/42; G05D 1/10; A47G 29/1201; A47G 29/124; A47G 29/1225; A47G 2029/1226

(57) ABSTRACT

A drop box apparatus is provided including a defined cavity capable of storing packages. A drop-off opening is disposed and arranged to receive at least one package from an unmanned vehicle, and a pick-up opening is disposed and arranged to provide access to the package by a recipient. At least one path connects the defined space, drop-off opening, and the pick-up opening.

### CROSS-REFERENCE TO RELATED APPLICATION

This application is a continuation-in-part of U.S. application Ser. No. 15/061,264, filed on Mar. 4, 2016, which claims the benefit of U.S. Provisional Application No. 62/233,872, filed on Sep. 28, 2015, each of which are herein incorporated by reference in its entirety.

### FIELD OF THE DISCLOSURE

The disclosure is generally directed to unattended package delivery, and more particularly, to an unattended drop box apparatus and system for receiving packages delivered by unmanned vehicles.

### DESCRIPTION OF RELATED ART

Products can be shipped to virtually anywhere in the world and are increasingly available from a variety of sources, businesses, and individuals. Along with availability of products, demand for speed and efficient distribution and delivery of products also increases. In particular, Internet commerce drives a market interest in providing secure, efficient, delivery of products directly to the customer.

Conventional shipping and delivery methods make product delivery available to customers at virtually any address. Customers frequently have access to package location and delivery timing information at various points from purchase to delivery. Despite available package tracking information, courier delivery services regularly attempt delivery at locations at which the intended recipient is not ultimately present or available to receive the delivery. If no signature or confirmation is required and no one is present at delivery, packages may be left outside the door of the delivery address. Unattended deliveries are often left in plain view of passersby in unsecured locations. Deliveries requiring a signature or confirmation of receipt may result in a delayed receipt, multiple delivery attempts, or may result in returning the package to the sender. Some deliveries are left at central delivery locations (e.g., reception area of an office, lobby of a condominium, mailroom, exterior door of a townhouse, or other public area). Other deliveries are left with someone other than the recipient (e.g., doorman, receptionist, or roommate). Additional factors that may affect success and timeliness of a delivery can include obscured street address numbers, non-street facing entrances, security gates, restricted access areas, multi-buzzer doors, inclement weather, and unrestrained animals. Multi-family or multi-business units may centrally deposit deliveries for multiple addresses in self-service, unattended and insecure locations such as a general mail room.

Delivery methods also become more sophisticated as delivery demand increases, and new technologies are developed. Distribution and transportation methods for package delivery are increasingly automated. New technologies include automated methods of shipment using unmanned vehicles. Unmanned aerial vehicles, also known as “UAVs” and “drones,” are being developed that can transport loads of increasing sizes over greater distances. The development of drones for use in package delivery is ongoing.

### BRIEF SUMMARY

Improvements may be made in conventional package delivery. Apparatus, systems, and methods are also desired to incorporate and complement the application of drone technology for package delivery. Apparatus, systems, and methods facilitating unattended drone package delivery are provided.

In one embodiment, a drop box apparatus is provided with a defined cavity capable of storing packages. The unattended drop box apparatus includes a drop-off opening disposed and arranged to receive at least one package via an unmanned vehicle and a pick-up opening disposed and arranged to provide access to the package via a recipient. A path connects the defined cavity (e.g., a secure internal chamber for storing packages), the drop-off opening, and the pick-up opening.

In another embodiment, a system for drop box package delivery is provided. The system includes a drop box apparatus, a processor associated with the drop box apparatus, and at least one memory including computer program code for one or more programs. The memory and computer program code are configured to, with the processor, cause the drop box apparatus to accept a package from an unmanned vehicle via a drop-off opening of the drop box apparatus. An access code input is received by a user, identifying the user as a recipient of the package. The package is produced to a pick-up opening of the drop box apparatus, such that the package is accessible to the recipient.

In a further embodiment, a method of unattended package delivery is provided. The method includes receiving an indication that a package has been delivered to a drop box apparatus via an unmanned vehicle. A recipient of the package is identified, and a notification indicating receipt of the package by the drop box apparatus is generated. The method also includes generating an access code associated with the package, providing the notification and the access code for display to a client device of the recipient, and generating an acknowledgment upon pick-up of the package by the recipient via the drop box apparatus.

### BRIEF DESCRIPTION OF THE DRAWINGS

Objects, features, and advantages of the present invention will become apparent upon reading the following description in conjunction with the drawing figures, in which:

FIG. 1A is a diagram illustrating one embodiment of a system for unattended drop box package delivery according to the teachings of the present disclosure;

FIG. 1B is a diagram illustrating another embodiment of a system for unattended drop box package delivery according to the teachings of the present disclosure;

FIG. 2A illustrates one embodiment of a drop box apparatus for a system such as that shown in FIG. 1A;

FIG. 2B illustrates another embodiment of a drop box apparatus for a system such as that shown in FIG. 1A;

FIG. 2C illustrates selected interior portions of one embodiment of a drop box apparatus for a system such as that shown in FIG. 1A;

FIG. 2D illustrates selected interior portions of another embodiment of a drop box apparatus for a system such as that shown in FIG. 1A;

FIG. 2E illustrates selected interior portions of another embodiment of a drop box apparatus for a system such as that shown in FIG. 1A;

FIG. 2F illustrates one embodiment of a drop box apparatus for a system such as that shown in FIG. 1B;

FIG. 3 is a block diagram of an embodiment of an unattended drop box apparatus for a system such as that shown in FIG. 1A;

FIG. 4 is a block diagram of an example drone of the subject technology for drop box package delivery according to the teachings of the present disclosure;

FIG. 5 is a block diagram of an example server of the subject technology for drop box package delivery according to the teachings of the present disclosure;

FIG. 6 is a block diagram of an example client device of the subject technology for drop box package delivery according to the teachings of the present disclosure;

FIG. 7 is a flow diagram of one embodiment of the subject technology for unattended drop box package delivery according to the teachings of the present disclosure;

FIG. 8 is a flow diagram of one embodiment of a method of unattended package delivery utilizing the subject technology according to the teachings of the present disclosure; and

FIG. 9 is a flow diagram of one embodiment of a method of unattended package delivery utilizing the subject technology according to the teachings of the present disclosure.

### DETAILED DESCRIPTION OF THE DISCLOSURE

The disclosed embodiments of apparatus, systems, and methods for unattended package delivery solve or improve upon one or more of the above-noted problems and disadvantages with prior known apparatus, systems, and/or methods. The disclosed embodiments may reduce delivery delays and failed delivery attempts by creating autonomy in the relationship between package arrival time and actual time of receipt. Packages may be protected from damage and theft between these two times by limiting or prohibiting access to packages. Greater flexibility in delivery timing is provided to senders, delivery service providers, and recipients. Further goals of the disclosed embodiments include resolving and reducing difficulties in using drones (used interchangeably herein with “unmanned vehicles,” “unmanned ground vehicles,” “UGV's,” “unmanned aerial vehicles,” or “UAV's”) for package delivery at destinations within high-rise buildings, gated communities, multi-unit structures, and partially covered areas. Additional goals are also met of providing convenient locations for individuals to initiate deliveries and providing flexibility through transferring packages to another address after arrival.

Instead of directing package delivery to an address associated with a recipient's home or office, a secure, unmanned structure is used as the delivery address. These structures, hereinafter called “drop boxes,” “drone drop boxes,” “DDS,” “drop box apparatus,” “unattended drop box,” and/or “unattended drop box apparatus” are located in areas of convenience to package recipients. Drop boxes may constitute an entire system or a portion of a larger system. Drop boxes may be located at an individual's residence, such as in the yard, on or in a shed, or on the roof of a recipient's home. Drop boxes may be located at the end of a neighborhood street to receive packages for the entire neighborhood. An apartment, office building, or condominium may have one or more drop boxes near or connected to the exterior of the building to receive packages for its tenants and residents.

The drop box may also hold multiple package deliveries and may be configured using mechanical or electronic mechanisms for sorting packages based on size, weight, volume, shape, recipient information, time of arrival, or urgency. Sorting may be performed immediately upon delivery. Sorting may occur by virtue of selection of different package entry points. Storage within the drop box may be integral with the path between drop-off and pick-up openings of the structure. Additional, or alternative, storage areas may be provided within the drop box. The physical structure and layout of the drop box provides protection from weather related damage. The physical structure may limit or prohibit visibility of the packages inside the drop box. Additional security may be provided by limiting access to some storage areas during package retrieval using multiple pick-up openings, locks, pass codes, biometric security devices or other measures to limit access to intended recipients.

Delivery notifications may be sent to a recipient's smart phone or another electronic device. A user may select a default setting to specify delivery locations or other details. Real time package tracking may also be sent to the recipient, sender, or intermediate delivery service. Single use security passcodes may be used to prevent theft and/or inadvertent pick-up by another user. A group of drop boxes and/or drones may work in concert to provide flexibility in delivery speed and delivery location.

The disclosed drop box apparatus, systems, and methods can include any one or more of the features as disclosed herein in different combinations and sub-combinations, and may include combinations of any two or more of the features disclosed herein.

### System Architecture

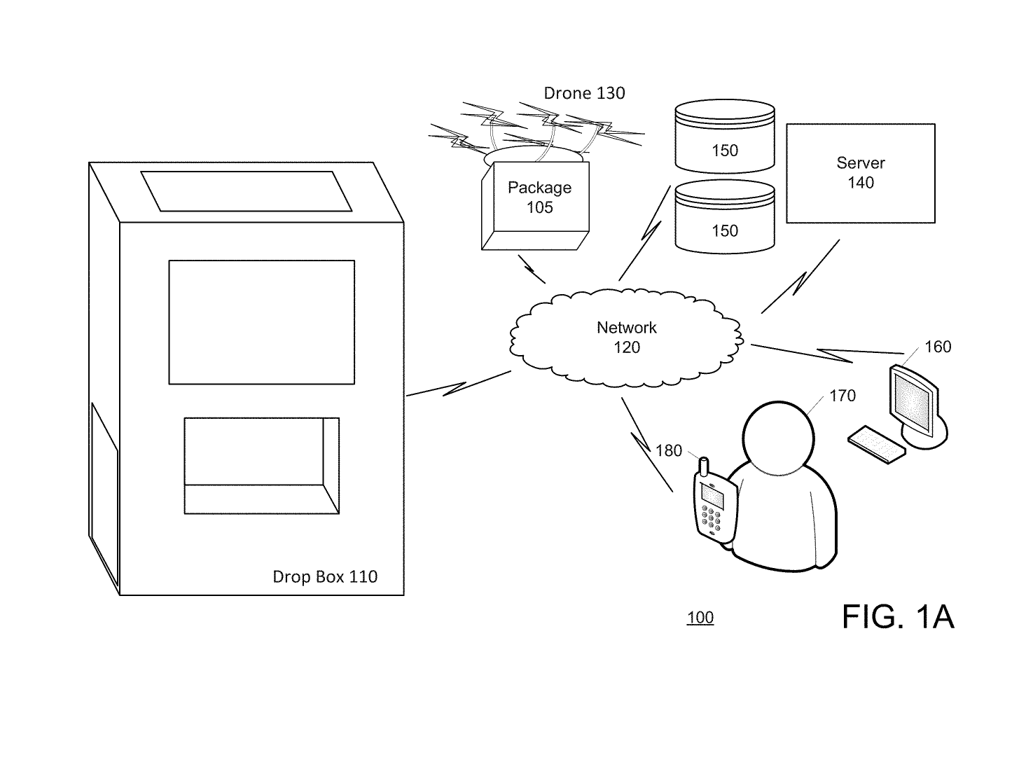

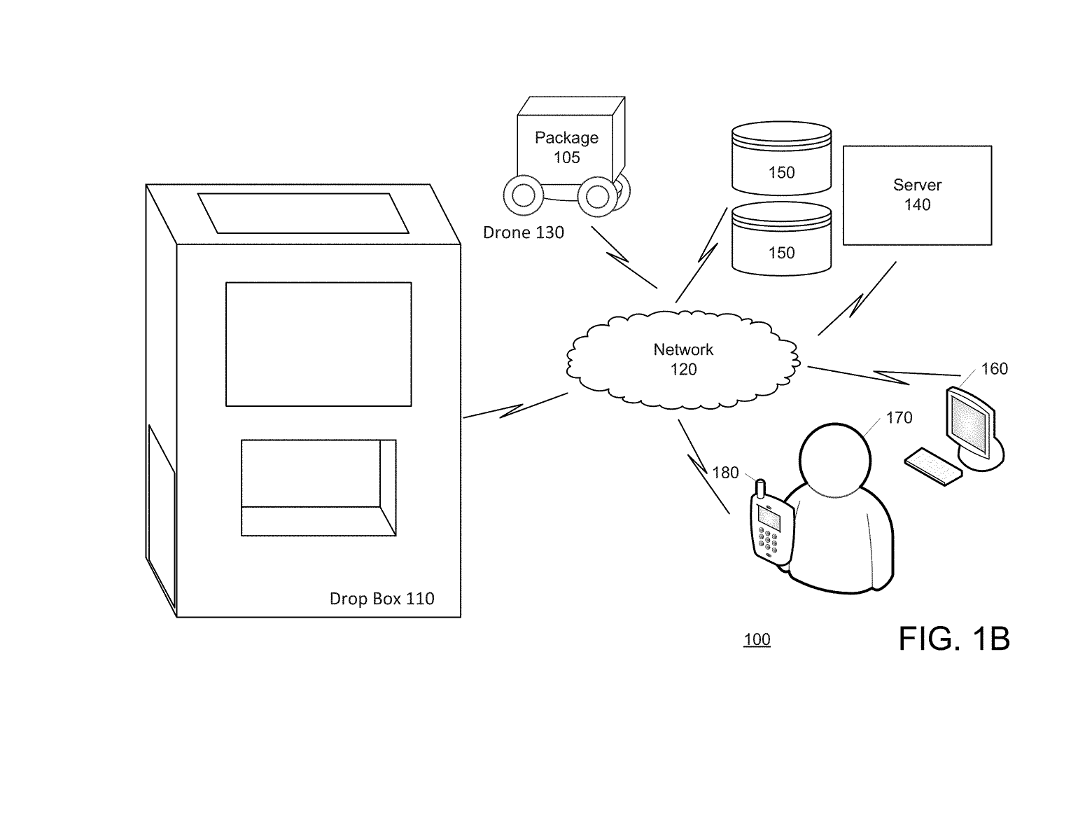

The unattended drop box apparatus may constitute an entire system. Alternatively, or additionally, a drop box may be one component among other components of a system which may include a drone, a client device, and/or a server. FIG. 1A and FIG. 1B illustrate embodiments of an example system 100 for drop box package delivery. The system 100 may include a package 105, a drop box 110, a network 120, a drone 130, a server 140, databases 150, and one or more client devices such as a personal computing device 160 and a mobile device 180. Additional, different, or fewer components may be provided in a system for drop box package delivery. For example, multiple drop boxes 110, drones 130, and client devices 160 and 180 may be included in some embodiments. In some embodiments, the drone 130 may be an unmanned vehicle capable of aerial travel, as illustrated in FIG. 1A. In other embodiments the drone 130 may be an unmanned vehicle capable of ground travel. The drone 130 may be capable of multiple types of travel, such as air, water, and/or ground. A user 170 may be the intended recipient or other user acting with the authority of the intended recipient of a delivery. A user may be any individual or entity (e.g., sender, recipient, courier delivery service, drone delivery service, or merchant.) One or more users 170 may interact with the system 100 using multiple computing devices 160 and/or mobile devices 180. Interactions may include receiving and/or transmitting any information associated with a drop box package delivery. Users 170 may interact with the system 100 as a recipient and as a sender.

System components may interact using one or more mechanical connections, electrical connections, wireless communications over a network 120, or combinations thereof. Components in the system 100 may be connected or connectable to other components via one network 120 or multiple networks 120 of the system 100. Components of the system 100 may connect or communicate with networks outside of the system 100. Multiple components of the system 100 may be physically integrated or physically housed within the drop box apparatus 110. Non-limiting descriptions of individual system components are provided below.

### Drop Box Apparatus

The unattended drop box apparatus 110 receives packages from unmanned vehicles 130 for pick-up by a user 170. Users may also deposit packages at a drop box 110 for pick-up by another user or pick-up by a drone 130. The drop box 110 may receive, protect, store, sort, and/or provide packages for drone pick-up. Packages refers to any physical items including, but not limited to: items packaged in envelopes, items packaged in mailers, boxed products, unboxed products, groceries, purchases, and the like. Information transmitted and received by the drop box 110 (or other components of system 100) includes data associated with package content, location, recipient, estimated timing, package destination, package location information, package delivery information, drone information, drone location information, estimated time and/or location data as well as similar information associated with courier delivery services. The system 100 and the drop box 110 may provide information associated with the package from the sender of the package, the distribution center, and/or an intermediate carrier or delivery service outside of the system 100.

The drop box 110 may be a freestanding structure, connected to another structure, or integrated as a unit or piecemeal with or into another structure. The drop box 110 may be constructed in a variety of sizes and shapes. The drop box 110 may include a housing the size of a soda machine or other vending machine. In other embodiments a drop box may be larger, (e.g., along an entire side of an apartment building, one or more stories tall, similar in size to a trailer or vehicle, or similar in size to a closet or office). Other embodiments may include smaller housings sized and shaped according to an individual drop box's maximum package dimensions or accepted types of packaging (e.g., commonly sized packaging, document mailers, standard paper sizes, envelope sizes, and shoe boxes). Sizes of drop boxes 110 may also be based on expected delivery volume in a surrounding geographical area or historical delivery volume in the surrounding area. The drop box 110 may be interchangeable or adjustable to accommodate maintenance, repair, changing current average package size, delivery volume trends associated with a season or time of year, or the like. Accordingly, a small drop box 110 may be replaced with a larger drop box 110 if the historical delivery data associated with the location increases proportionally over time. Size of permitted deliveries may also be managed based on the volume of packages currently stored inside the drop box 110 or apparatus or may be determined based on the overall capacity.

Some or all of the drop box 110 or apparatus may be constructed of material or configured such that the interior of the drop box is weatherproof and/or waterproof. Insulation may be used to reduce internal temperature changes. Material density may be selected to withstand exposure to inclement weather and the elements. Some or all of the drop box 110 or apparatus may include a housing that is made of metal, another rigid, non-porous material, or other suitable material. In one example, the drop box 110 or parts thereof can be made of metal, recycled metal, recycled material, or other rigid and secure material to deter tampering.

Geographic locations of the drop boxes 110 should be convenient to individual residences, streets, intersections, common areas, or buildings. Drop box locations may be dictated based on existing geographic and structural features or may be integrated into construction plans for apartment buildings, condominium buildings, houses, shelter structures, commercial properties, hotels, shopping malls, parks, airports, and the like. A drop box 110 may be centrally located with respect to an individual residence, neighborhood, main entrance, frequently used entrance, a well-traveled route, or a convenient intersection. Location of the drop box 110 or apparatus may be determined using historical delivery information, traffic information, client device geolocation information, and the like. Drop boxes 110 may be connected, attached, installed, or integrated with existing apartment buildings, condominium buildings, houses, commercial properties, hotels, parks, airports, and the like. The drop box 110 or apparatus may be attached, installed, or integrated into bike storage facilities, bus stops, carports, garages, partially covered areas sporting arenas, amphitheaters, gazebos, or other partially enclosed structures. Drop boxes 110 adjacent to buildings or other structures may be positioned partially inside and outside of a connected building. Outdoor portions may include openings used by drones and may be located on the exterior of an existing structure, simplifying drone navigation. User pick-up openings, maintenance access, and/or storage portions may be located inside or under shelter of the connected building or structure, providing user convenience while reducing package damage. The drop box 110 or apparatus may be oriented or positioned to maximize shelter from the elements. Openings of the drop box 110 may be further positioned to provide shelter. An aperture or opening on the drop box 110 may be adjustable based on package size, drone type, drone size, or height of the user.

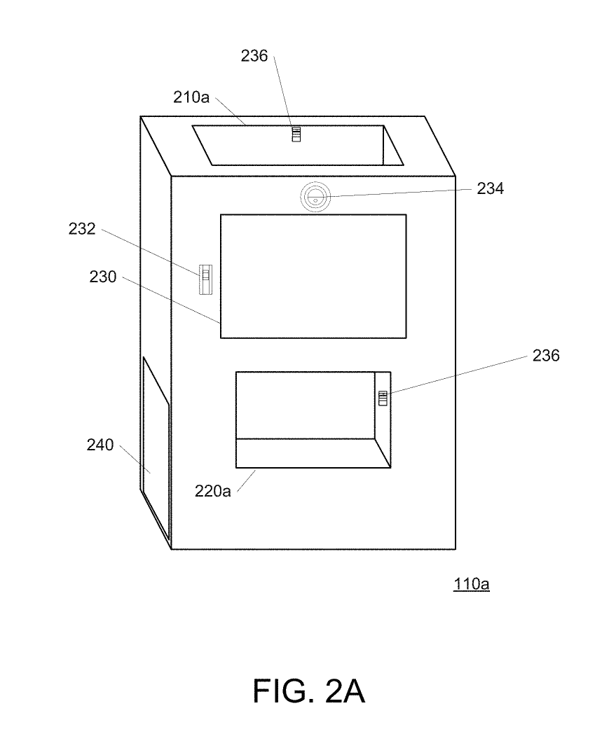

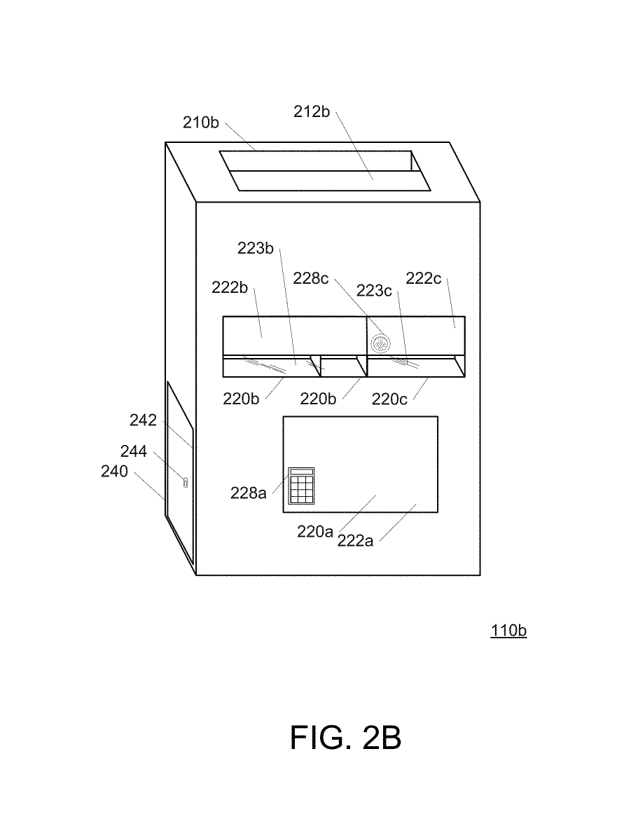

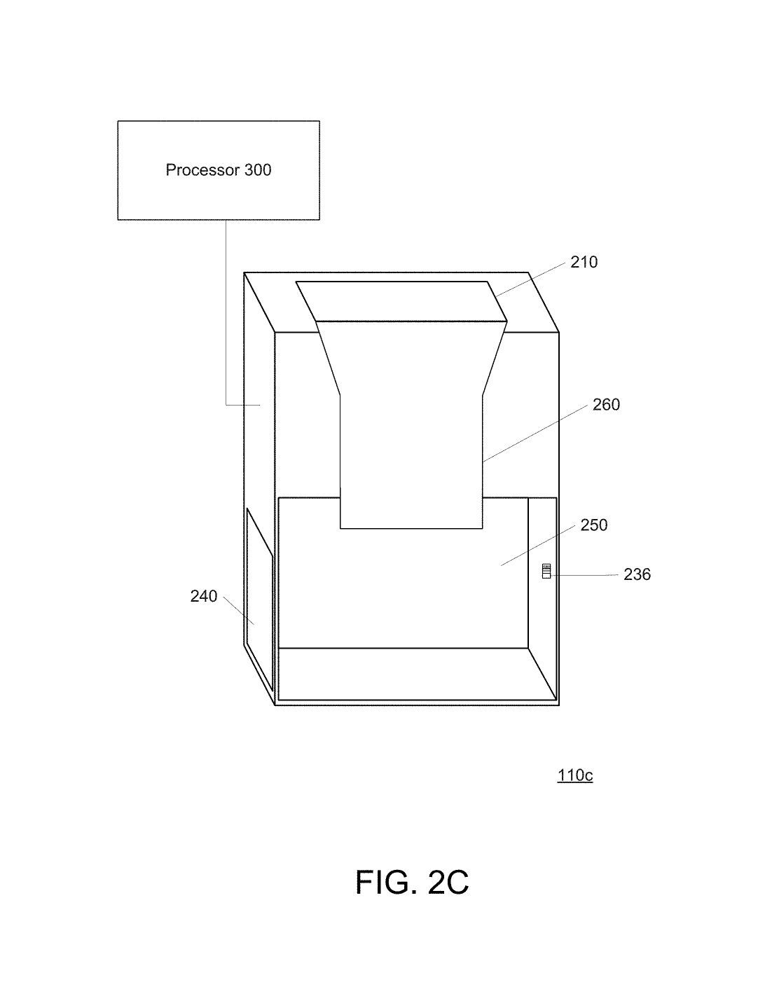

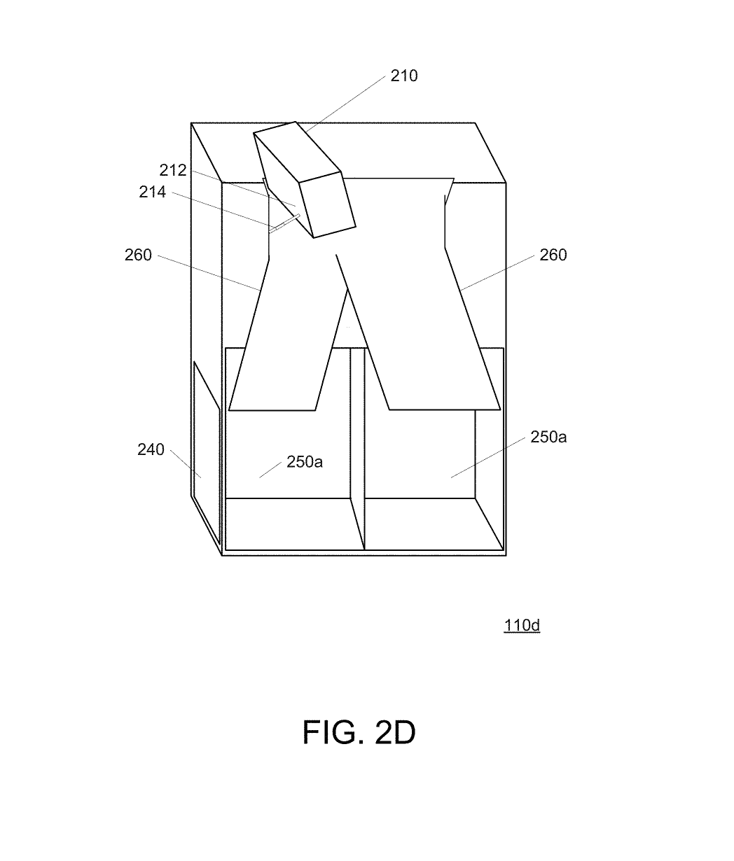

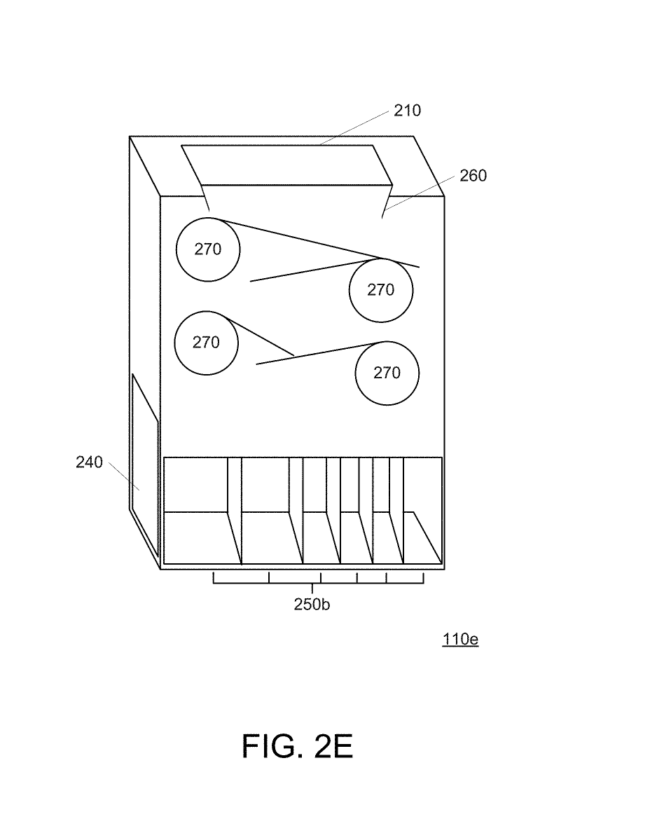

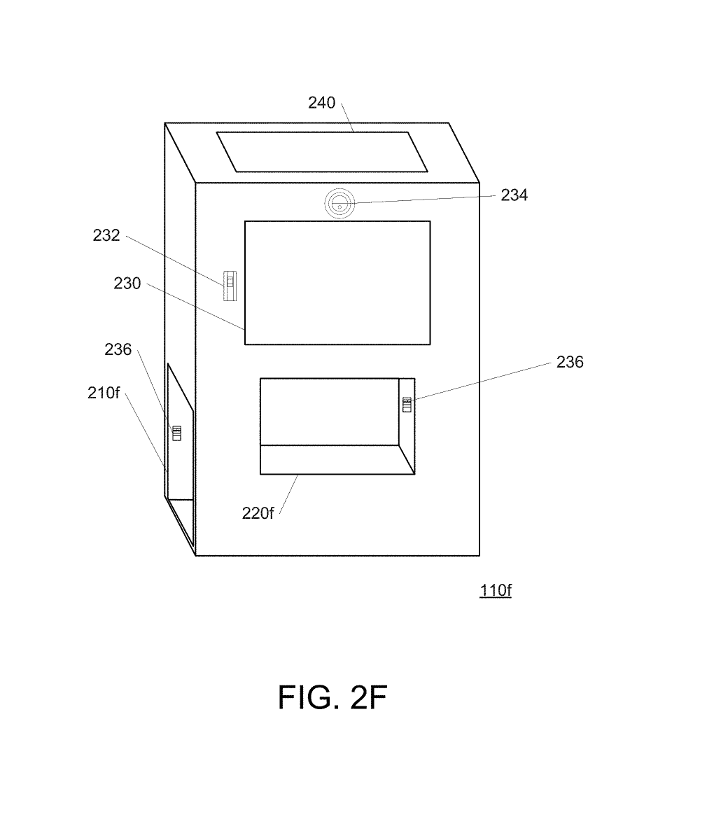

FIGS. 2A-2F illustrate partial views of possible embodiments of the drop box 110 of FIGS. 1A and 1B. Additional, different, or fewer components are possible for the unattended drop box 110 or apparatus. It is contemplated that features of one embodiment may be combined with features of another embodiment. FIG. 2A illustrates an exterior view of one embodiment of a drop box apparatus 110a. The drop box 110a may include a drone drop-off opening 210, a user pick-up opening 220a, a user interface 230, the scanners 236, a camera 234, and a maintenance opening 240. A defined cavity 250 (depicted in FIGS. 2C-2E) is located inside drop box 110 and is capable of storing packages, such as the package 105 of FIGS. 1A-1B. A path (depicted in FIG. 2C) or multiple paths (depicted in FIGS. 2D-2E) may connect the defined cavity 230, the drop-off opening 210, and the pick-up opening 220.

The drone drop-off opening 210 is disposed and arranged to receive drone deposited packages. The drone drop-off opening 210 may include movable cover, door, flap, or other covering that is movable to allow drone drop-off of packages while protecting the inside portion of drop box from weather, debris, and to prevent access to the drop box other than delivery or pick-up of packages by the drones 130 serving drop box 110. Some drop box 110 embodiments may have no covering or other closure. Thus, drop-off opening 210a is an open access point of drop box 110a. drop-off openings 210a may be preferred in embodiments in which the drop box 110 is located in a secured area and/or is sheltered by a roof or other existing structure. For example, a drop box 110 located on a roof of a condominium. Roof access to the condominium may be limited to authorized building personnel only, or drop box 110 may be enclosed by a porch, gate, fence, cage or other structure preventing unauthorized access to the drop-off opening 210a. The enclosure may prevent access to drop-off opening 210a. The enclosure may have an opening framing the pick-up opening 210a and user interface 230 that does not limit user interaction with the drop box 110. Drop-off opening 210a may be covered or partially covered by another existing structure, such as a partial roof, overhang, or other covering. In these embodiments, weather, debris are prevented from affecting the interior of drop box 210 without creating an obstruction to the drones 130 that negatively impacts package delivery and/or pick-up. The drop-off opening 210a may be preferred in embodiments in which a drop box 110 is integrated into a building or other structure. Drop-off opening 210a may be connected to portions of an exterior structure such as a chute, path, connected to an exterior portion of the structure.

The drop-off openings 210 may be disposed in a top-most surface of the housing on the drop box 110 but may also be disposed on a side of the drop box. The drop-off openings 210 may be disposed on the drop box 110 for compatibility with aerial drone delivery, ground drone delivery, or water based drone delivery. Multiple drop-off openings 210 may be disposed on drop box 110 to accept delivery from different types of drones. A moveable covering for the drop-off opening 210 may be disposed so as to cover all of or a portion of the drop-off opening. A covering of the drop-off opening 210 may include a diverter door directing a path of received packages concurrent with closure of the covering. The packages 105 can be stored and sorted within the defined cavity 250 by components of the drop box 110 itself. The user pick-up opening 220 may be further disposed and arranged to receive user deposited packages, i.e., outgoing packages from a user. Such outgoing packages may be moved by the drop box 110 from the pick-up opening to the defined cavity 250 and, when ready for pick-up, to the drop-off opening by components of the drop box. User deposited packages may then be accessed and retrieved by a drone via the drop-off opening 210.

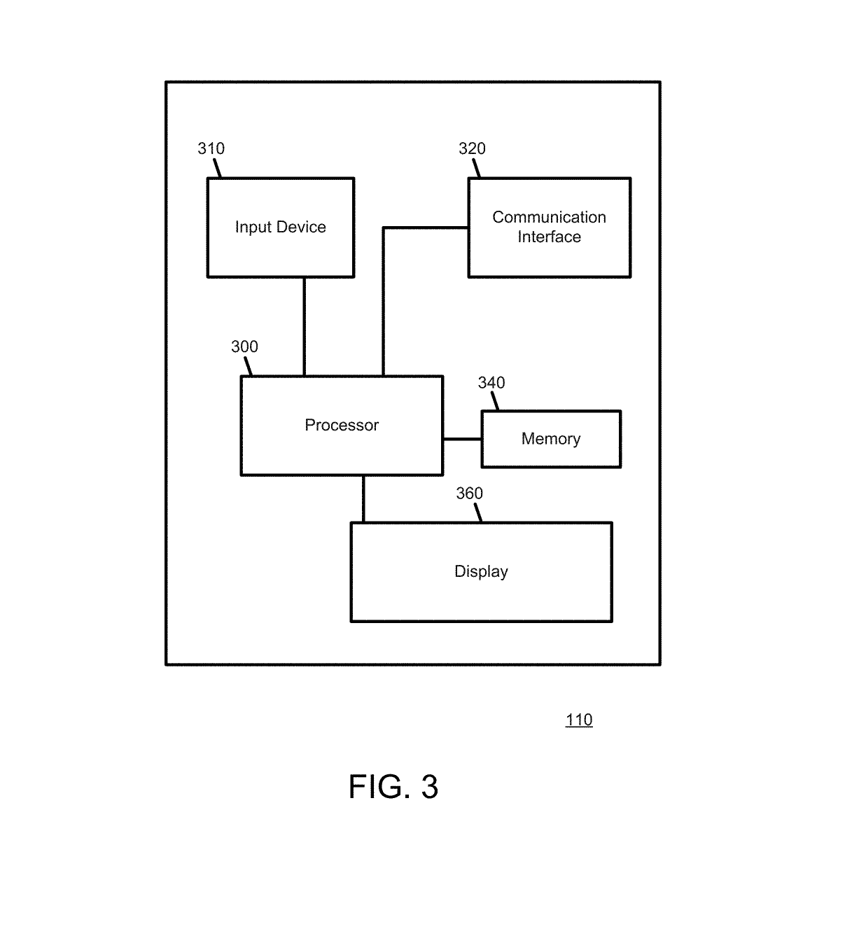

The user interface 230 may be an interactive display such as a graphical user interface (which may include both an input device 310 and a display 360 as described in FIG. 3). The user interface 230 may provide prompts to a user requesting to provide identification information, security access codes, payment, loyalty program identification information, and other information associated with a user retrieving a package that has been delivered to the drop box. Additional input devices may be provided near the user interface 230, such as a scanner 232 or other input device. Bar codes, QR codes, or images security keys may input from scanner 232 at the prompting of user interface 230 as a user retrieves or deposits packages. Camera 234 may be a security camera providing a live feed, motion operated recording, or may be focused, moved, or operated by a processor 300 of the drop box. The scanners 236 may be any type of scanner that may identify a current location of the package. The scanners 236 may also identify information associated with the recipient, contents, or other data. Scanners 232 and 236 may send package information to processor 300 of drop box 110 and/or may transmit package information via network 120 to a merchant, distributor, or recipient.

FIG. 2B illustrates another embodiment of a drop box apparatus 110 of FIG. 2A. The drop box 110a of FIG. 2B includes the features illustrated in FIG. 2A but with additional pick-up openings 220b, 220c a maintenance door 242 with a lock 244. Additional features of FIG. 2A include doors or covers 222a, 222b, and 222c, security devices 228a, 228c for pick-up openings 220a, 220b, 220c. One or more pick-up openings 220a, 220b, or 220c may be dedicated to user deposited outgoing packages only. Doors 222b, 222c may include a portion 223b, 223c that is transparent or semi-transparent. Door 222b may provide access to multiple pick-up openings 220b. Each pick-up opening may have its own door such as door 222c and 222a. One or more pick-up opening 220a may provide direct access to cavity 250. The drone drop-off opening 210b may include a cover 212b. Cover 212b may be a partial covering of opening 210b. Cover 212b may be fastened to drop box 110 such that the cover may open and close. Security device 228a may include a keypad and display. A single use or unique security code may be entered into security device 228a and partly or fully be controlled by processor 300. Upon entry of the correct code by the recipient, the security device 228a may be unlocked and provide access to pick-up opening 220a. Security device 228c may include a combination lock, providing limited access to pick-up opening 220c. The security code or combination may be controlled and/or programmed via processor 300, limiting access to the pick-up opening based on the recipient of package 105 contained in the pick-up opening 220c.

FIG. 2C illustrates selected interior portions of one embodiment of a drop box apparatus 110c. A defined cavity 250 may be a partial enclosure or a full enclosure connected to the drone drop-off opening 210 via a path 260 and/or connected to the pick-up opening(s) 220. The cavity 250 may be directly accessed by a user via the one or more pick-up openings 220 and may include a scanner 232. Alternatively, components of the drop box 110c may move packages to a pick-up opening 220, when ready, via another path (not shown). The path 260 may be configured to include a sorting mechanism (e.g., partitions, motors, conveyors, bumpers, paddles, partitions, etc.) directing received packages from the drop-off opening 210 to subdivided storage areas (not shown) of the dedicated cavity 250.

FIG. 2D illustrates selected interior portions of another embodiment of a drop box apparatus 110d. Drop-off opening 210 may include a diverter door 212 and mechanism 214 of diverter door 212. Mechanism 214 may be controlled by processor 300 of drop box 110d to specifically direct packages into one of storage areas 250. Storage cavity 250 may be subdivided into multiple different storage areas 250a. A single pick-up opening 220 (not shown) or multiple pick-up openings 220 (not shown) may provide access to packages to each of the subdivided storage areas 250a. Again, internal components of the drop box 110d may instead operate to move packages from the storage areas 250 to an appropriate pick-up opening 220, when needed. Access to the subdivided storage areas may be limited by providing only one pick-up opening 220 allowing access to selected, subdivided storage areas. Multiple pick up openings 220 may service individual subdivided storage areas 250a, with access based on entry of a different security access code for each pick-up opening 220. A door may be closed over each pick-up opening 220 and each door may be configured to be opened only upon entry of a security code by a user or recipient.

FIG. 2E illustrates selected interior portions of another embodiment of a drop box 110e or apparatus. A path 260 may include one or more selection mechanisms 270 that are configured to direct the received packages 105 to a pick-up opening 220 or to a storage area or cavity 250. Selection mechanisms may include one or more diverters, levers, conveyors, paddles, and/or the like, electrically powered circuitry, computing hardware, and software controlled by a processor 300 associated with the drop box 110e. The processor 300 may direct the selection of a cavity 250 or a subsection of a cavity 250b for storage or retrieval of a package based on data associated with the current drop box state or content. Direction may include selective operation of the mechanisms 270 to receive or distribute packages in addition to selective operation of the mechanisms configured to internally move, sort, store, organize, and deliver packages at any point between the drop-off opening 210 and the pick-up opening 220 (e.g., along the path 260, within the storage cavity 250, or within a subsection of cavity 250) based on a determined pick-up opening.

FIG. 2F illustrates one embodiment of a drop box apparatus for a system such as that shown in FIG. 1B. FIG. 2F illustrates an exterior view of one embodiment of a drop box apparatus 110f. The drop box 110f may include a drone drop-off opening 210f, a user pick-up opening 220f, a user interface 230, the scanners 236, a camera 234, and a maintenance opening 240. A defined cavity 250 (depicted in FIGS. 2C-2E) is located inside drop box 110 and is capable of storing packages, such as the package 105 of FIGS. 1A-1B. A path (depicted in FIG. 2C) or multiple paths (depicted in FIGS. 2D-2E) may connect the defined cavity 230, the drop-off opening 210, and the pick-up opening 220.

Drop off opening 210f may be located on a side of the drop box 110f. Disposing the drop-off opening 210f on a side of drop box 110f may advantageously provide access to unmanned ground vehicles such that the vehicle may drive into the drop box 110f in order to deliver the package. A covering or door as disclosed herein, may be used to restrict access through pick-up opening 220. The door may close while drone 130 is delivering the package 105 to drop box 110f. The maintenance opening 240 can be on the top of the drop box 110f in this example since the drones 130 are ground based. However, the drop box could include a side drop off opening and a separate drop off opening in the top of the drop box to accommodate both aerial and non-airborne drone drop off.

As will become evident to those having ordinary skill in the art, the drop box configuration and construction can vary from the simplified examples shown and described herein. The drop box 110 can include secure pick-up openings with security doors that only open upon input of a security code or the like. Packages may go direct from the drop-off opening to a predetermined available one of the pick-up openings. Instead, the drop box may include one or more interior storage cavities or areas in which packages are stored until ready for pick-up. When ready, such as when a user sends a signal to the drop box or enters a security code or the like, the drop box may move a specified package to a pick-up opening. In such an example, the pick-up opening may be unsecured or secured and the drop box may include one or more than one of the pick-up openings.

FIG. 3 is a block diagram illustrating computer hardware and/or software of one embodiment of a drop box or apparatus such as the aforementioned drop box 110. The drop box 110 includes an input device 310, a communication interface 320, a processor 300, a memory 340, and a display 360. Additional, different, or fewer components are possible for the drop box 110.

The processor 300 and at least one memory 340 including program code for one or more programs controlling operations of the drop box apparatus 110 and/or to communicate with a user. The processor 300 may include a general processor, a digital signal processor, an application specific integrated circuit (ASIC), a field programmable gate array (FPGA), an analog circuit, a digital circuit or combinations thereof. The processor 300 may be a single device or a combination of devices. The processor 300 may work in tandem with one or more servers 140 via the network 120 to perform one or more acts in accordance with one or more disclosed embodiments. The drop box 110 may have one or more integrated processors 300 or may include remotely located processors 300 with wireless or wired communication capabilities to or with the drop box 110.

The input device 310 may include one or more touchscreen, keyboard, pointing device, mouse, trackball, image scanners, biometric sensor, camera, microphone, or other peripherals capable of receiving input from a user in any form. The input devices 310 may be placed in the interior of the drop box 110, so that scanners and readers (e.g., 236) capable of identifying and tracking existing package information via barcodes, QR codes, scanners, RFID, serial numbers, or other available package identification may track the location of packages inside the drop box. For example, the scanners 236 may be located in storage cavity 250, in pick-up opening 220a, drop-off opening 210, and/or anywhere along path 260. Scanners 236, for example, may be placed along the path at each point of sorting. Existing sources (such as merchant or courier delivery services or systems) of delivery tracking, cellular communication, geolocation or other existing notifications may transmit or receive information to drop box 110. The input devices 310 (or other components of the drop box 110 or system components) may be peripheral devices that are integrated or electrically connected.

The one or more memories 340 may be a volatile or non-volatile memory including one or more read only memory (ROM), random access memory (RAM), flash memory, or other type of memory.

The communication interface 320 may include any operable connection including signals, physical communications, and/or logical communications transmitted and/or receipt, whether wired or wireless between any combination of users.

The display or displays 360 may include a screen or a graphical user interface incorporating an input device 310 (e.g., a touchscreen). The displays 360 may include advertising space. Advertisement space may include electronic displays or a non-electronic space for signage. Electronic advertising space such as a display screen 360, may also include interactive screens, speakers, or other output components. Interactive peripheral devices may include advertising displayed or provided when the drop box is not currently in use and/or has been in an idle state for a certain period of time in the same fashion as a screensaver.

Other specialized devices of the drop box 110 may include drone charging stations. Drones 130 may be permitted to recharge at the direction of the drop box 110 or system 100. The drop box 110 may identify a drone's current power level or other associated information. Drones with lower power or greater distances to travel may be automatically permitted to charge for a predetermined period of time or until achieving a predetermined power level. For example, any drone with less than ten percent of its power storage capacity may be permitted to recharge for a pre-determined period of time. The predetermined period of time may be proportional to the charging speed and electric current maximums of the charge protocol of the drone 130. The duration of permitted recharging period of time or recharging power threshold may be determined based on one or more drone schedules and/or instructions, expected scheduled deliveries, user pick-up or drop-off reservations, or exclusive user rental of a drop box 110. Similarly, recharging may be prohibited based on drone delivery schedules, a determined current congestion level, or expected periods of time with frequent use. The drop box charging stations may provide charging via contact or noncontact (e.g., inductive charging) and may be located on top of the drop box 110 or housing, or on a roof of an adjacent building. The charging system may be available to the drone while completing a delivery. A drop box 110 may have multiple charging stations. A charging system may be located proximate to a drop-off opening 210 so that one drone 130 may be charged while the drop box 110 simultaneously receives a package 105 from another drone 130.

The drop boxes 110 may additionally include integrated or peripheral devices configured to receive money, credit card, chip-cards, contactless cards, electronic payment, or other forms of payment. Credit card electronic or scan devices associated with the drop box 110 may also be used with loyalty programs, barcodes, alphanumeric codes, or other loyalty and offer based information. These peripheral devices may be used in the process of a user receiving and withdrawing a package 105 from the drop box 110. These peripheral devices may also be used to schedule a pick-up, for shipping, to reroute, to store packages for pick-up, to provide packages for drone pick-up, to transfer packages to another drop-box, or to identify a user from the particular drop box 110.

In one example, the cavity 250 of the drop box 110 can include a defined space, cavity, or protective enclosure such as a cavity for package storage. The drop box 110 and/or cavity 250 can also include a drop opening (i.e., the drop-off opening 210 or an opening in communication with the drop-off opening), chute, or receptacle, or the like, into the defined space, cavity, or protective enclosure disposed and arranged to accept or receive packages from a drone 130. The drop box 110 may include the path 260 and/or a mechanism and/or a system for packages to pass or be passed from the drop opening, chute, or receptacle into the defined space, cavity, or protective enclosure. The pick-up opening 220 is or can be a portion of the drop box 110 in which the user may access a delivered package to complete delivery to the recipient. In some embodiments, the user pick-up opening 220 may also be a package deposit area when scheduling a package for drone pick-up from the drop-box 110. The pick-up opening 220 in some embodiments can also be a deposit area for a user to deposit packages that will be stored in the drop-box for pick-up by another user. The pick-up opening 220 may also be an open area, opening, area, or region, on the housing or separate from the housing and in communication with a part of the drop box 110 and can be provided for packages to be retrieved from the defined space, cavity, or protective enclosure by a recipient.

In some embodiments, a drop box 110 receives packages 105 through the specified drop-off opening 210. The drop-off opening 210 allows the drone 130 to drop or place packages 105 into the drop box 110. The drop-off opening 210 may be located on the top or side of a housing or a building or structure and can include a door, and/or an aperture associated with, or provided as, the drop-off opening. The drop-off opening 210 can be in package delivery communication with a chute, path, or receptacle, to allow packages to enter a portion of the drop box or housing. Such a drop-off opening 210 can be designed and configured to receive a package dropped or placed by drone onto or over the opening. The drop box 110 may have an aperture or door on the top or a side of a housing portion or the building structure. The aperture or opening allows drones 130 to drop or place packages into the drop box 110. In one example, a drone 130 arrives, a door opens (such as 212b), and the drone drops a package into the drop-off opening 210, and the door closes. The door may be operable by receiving a signal from the drone 130 as it approaches. The drop-off opening 210 may include linkage for the door or the drop-off opening that is mechanically operated based on gravity, weight of a package, drone interaction, or other methods.

Packages may be picked up by the intended recipient at a specified pick-up opening 220. Such a pick-up opening 220 may include a customer interface that is a portion of the opening. The drop box 110 may include a customer interface on a side or front of the housing where a customer or recipient may input security codes, security information, identifiers and the like in order to access the space within the pick-up opening 220 and to retrieve the deliver packages

The drop box 110 may have a secure section or portion for storing packages 105. That is, the storage portion 250 of the drop box 110 may include one or more subdivisions designed for receipt of valuable and/or confidential deliveries. Shape and location of the secure section or portion may contribute to increased security. Additional security portions may be located so that no surface of the subsection includes an exterior wall of the drop box 110 or housing. Denser material or more tamper resistant materials may also be used to enclose any such secure sections or portions of the drop box 110, storage cavity 250, or housing.

The user interface 230 may be located on the side of a housing or otherwise be accessible to the consumer or recipient so that consumers/recipients can communicate with the DDS in order to obtain packages. The user or recipient may need to interact with the user interface in order to gain access to a delivered package. In one example, the package to be retrieved may be held in a storage cavity 250 behind a door covering the pick-up opening 220. In another example, the package to be retrieved may be held in a separate or secure storage area 250. When the user or recipient interacts with the customer interface, the package can then be moved into a pick-up space or near the pick-up opening 220 for retrieval.

In some embodiments, the drop box 110 may distribute packages internally within a storage portion of the drop box. This configuration may include multiple openings, paths, storage areas, and the like paired with multiple retrieval or pick-up openings. Mechanical devices, sensor-based operation, and/or sort functions and components, may be operated and performed by the drop box 110 to sort packages upon receipt and prior to pick up by a user. The drop box 110 may include onboard software systems to log incoming packages, administer packages, reposition packages, distribute packages, shift packages and the like.

The drop box 110 may have a door 242 over another opening, i.e., a maintenance opening 240, in the housing or system to permit access for maintenance of the drop box 110 and its various parts and components and for authorized retrieval of packages 105 that have not been picked up by the intended recipient within a certain period of time. Such an opening or openings may further permit the maintenance of the storage areas and path from one opening and/or area or cavity to another in the event that a package has become stuck during the process of receipt, sorting, and/or retrieval. For example, if a package has been damaged during transit, such as a change in the anticipated volume or shape of the package, the package may not be effectively sorted. Such a maintenance opening 240 may additionally permit maintenance and cleaning of the interior of the drop box 110 and/or housing. For example, if an unauthorized user attempts to place a package in the drone delivery or drop-off opening 210 and pushes package inside of the drop box 110, the machine may be rendered unusable. The travel path of the packages through the drop box 110 may be cleared utilizing the maintenance opening. Lock 244 and maintenance door 242 limit entry into the drop box 110 via maintenance opening 240.

In some embodiments the drop box 110 may have wireless capabilities such that consumers and recipients may have communication capability with the drop box 110 for delivery system via an application, software, or other communication device. Retailers and distributors may additionally be connected with the drop box 110 in the same manner. Consumers, recipients, distributors, and/or retailers may receive alerts as to package status, drone status, when a package has been picked up by a drone, when a package has been delivered to a drop box, when packages are made available for pick-up or retrieval, and/or when a package has been retrieved.

The drop box 110 or other components of the system 100 may provide, determine, or receive GPS coordinates so that drones 130 can travel to specified locations to deliver or retrieve packages. In one example, the drop box 110 may emit a signal or “homing beacon” to be received by drones. The homing beacon may provide directions for the drone 130 and/or identify the location of the drop box 110. A homing beacon may include radio, acoustic, infrared, or any other emitted signal.

In one example, the drop box 110 may be configured to internally sort packages 105. The drop box 110 can utilize bar codes and/or RFID tags and/or the like. The drop box 110 may be configured to include one or more bar code readers or one or more RFID tag readers inside the drop box 110 and/or one or more RFID tag readers. Packages can then be provided with readable labels matched to the readers in the drop box 110. For example, readers may be placed at various points in the drop box 110 and/or along the package travel path. Such readers can be placed in a configuration that provides an identification when the package is accepted by the drop box 110 at the drop-off opening 210, an identification when the package reaches the storage cavity 250, and an identification as the user receives delivery of the package at the pick-up opening 220. These identifications of the package may be transmitted by the drop box 110 to a server or servers 140 and/or client devices 160 and/or 180 in order to provide specific tracking information to users of the system 100, such as the recipient, the sender, and any intermediate delivery services.

A drop box 110 may use gravity based sorting and purely mechanical internal sorting devices and may not require electrical power. Even in these embodiments, other portions of the drop box 110, such as user interface 230, may be electrically powered. Power may be supplied to the drop box or apparatus using a power line, battery power, solar power (e.g., photovoltaics or concentrated solar power), wind power, other alternative energy, or a combination of energy sources. Solar panels, batteries, or other energy sources may be physically disposed on the drop box 110, or energy may be stored or generated at a remote location and delivered to the drop box 110. Combinations of power sources may be selected to optimize drop box operation and control costs by using alternative energy when available. Battery or generator power may be reserved for power outages.

Drone Device Components

The drone devices 130 are configured to move packages from one location to another and may be controlled by or receive instructions from client devices 160 and/or 180, other drones 130, drop box 110, servers 140, or trained technicians over the network 120. The drones 130 may pick up and/or deliver packages to the drop box 110. The drones 130 may have some or all capability of client devices 160 and/or 180 in the network in addition to aerial, ground, and/or water navigation capabilities.

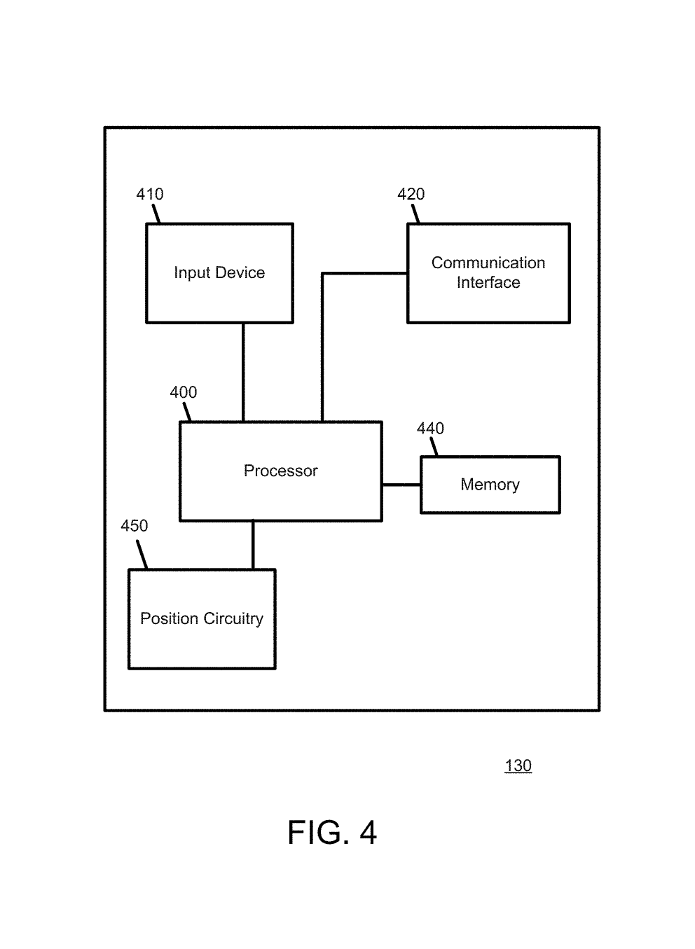

FIG. 4 is a block diagram of an example unmanned vehicle, unmanned ground vehicle, unmanned aerial vehicle, or drone 130, for unattended drop box package delivery. The drone 130 can include a processor 400, an input device 410, a communication interface 420, one or more memories 440, and position circuitry 450. Additional, different, or fewer components are possible for a drone 130. The drone 130 may be configured for aerial travel, ground travel, travel on water, or any combination thereof. The processor 400 and the communication interface 420 may be configured, connected, and function as described elsewhere in this document.

The positioning circuitry 450 may include geolocation circuitry such as a Global Positioning System (GPS), Global Navigation Satellite System (GLONASS), self-navigation system, or a cellular or other positioning system. Positioning systems may include sensor devices to obtain visual information, determine position, orientation, waypoint information, and other data in order to determine geographic location or route. The positioning circuitry 450 may communicate with trained personnel on the network 120 or remote computer systems.

Multiple drones 130 may be included within the system 100. A specific set or subset of drones 130 may service defined geographic areas such route, set of routes, a neighborhood, a geographically bounded region, a geometrically boundary region, or a selected set of drop boxes 110. One or more drones 130 may have a delivery area corresponding to ZIP Codes or ZIP+4 area codes. The drones 130 may operate between a supply source such as a warehouse or distribution center in communication with a one or more drop box locations. Assignments of the drones 130 to geographic areas and/or a group of drop boxes 110 may be determined over the network 120 or controlled by the remote servers 140 based on the status of in-process orders. The drones 130 may have a time-based schedule including regular drop-off times and drop box locations. Regular drop-off or pick-up times may be spaced in regular intervals (e.g., daily, twice daily, once a week, hourly, etc.). The drones 130 may be assigned additional deliveries based proximity of the additional delivery to the drone's regular route. Shipping speed requirements of the package, a request for delivery delay, or other user or sender selected parameters may dictate the route of one or more of the drones 130. Routes, drop-offs and pick-ups may be determined via a remote server 140 and communicated over a network 120. In response to individual user requests for delivery relocation from one drop box 110 to another drop box 110 or unscheduled, user initiated pick-up requests, proximity-based protocols may be used such that the nearest available drone 130 receives instructions to pick-up, transfer, or drop-off a package based on the current location, status, and schedule of the drone 130.

In one embodiment, a user may place a request via a user interface 230 of a drop box 110 for a package 105 that has been already delivered via drone to one drop box to be transferred via drone to another drop box 110. For example, the recipient may have received a notification that a package has been delivered to a drop box 110 near home, but the recipient would like the package transferred to a drop box at the office before the recipient leaves work at the end of the day. The recipient may place the package transfer request at the user interface 230 of the drop box 110 near his office. A drone 130 may be selected for immediate pick-up at the drop box 110 with instructions to retrieve the package. The drone 130 may then immediately transfer the package to the requested drop box 110. A drone 130 may be present at the drop box 110 at which the request is made. If the drone does not have current instructions, the drone 130 may remain at its last delivery location until receiving further instructions, promoting efficiency within the system 100. Some drop box locations may have a drone 130 dedicated to serving the delivery and pick-up needs for only that drop box 110. The drone 130 may remain at the drop box 110 while not in use. For example, the drop box 110 may be located at a large condominium primarily or exclusively servicing the residence of the condominium. One or more drones 130 may be exclusively assigned to the condominium's drop box 110 to ensure rapid delivery to the drop box, for residents to place user-initiated package pick-up requests at the condominium and to ensure rapid transfer of resident packages from other drop-box locations to the condominium's drop box 110. In some embodiments, the drop box 110 (optionally including any drones 130 exclusively assigned to the drop box 110) may be rented, reserved, licensed, or purchased for an individual user via client device 160 or 180. A reservation, rental, license, or purchase may apply to an entire drop box 110, one or more drop-off openings for a drop box 110, and/or one or more pick-up openings for a drop box 110. Reservations and rentals may be limited to a group of users (e.g., only residents of a condominium), although the drop box 110 may have a larger group of users (e.g., a drop box servicing the condominium and the townhomes located on the same street). In some embodiments, one or more drones 130 may be reserved and/or rented for consumer errands via a website or application. Reservations or rentals of one or more drones 130 may be limited in any way as described with respect to drop box 110. Other limitations may be based on the user's frequency of use of the drop box system 100, the frequency of use of a particular drop box 110, or that a user may pay proportional increases or decreases in fees associated with frequency of use, residence location, work location, or other parameters. Limitations and parameters may further be based on other variables, such as time of day for delivery, pick-up and/or transfer. For example, a drop box 110 may be available for rentals of one day at a time and/or for reservations of no more than one hour. Rental and reservation availability may be determined based on in-process deliveries, scheduled deliveries, regular pick-ups, regular routes, and the like.

The drop box 110 or apparatus may communicate with other drop boxes apparatus or with one or more drones 130 of the system 100. For example, in the event that a package delivery is not possible at one location, the apparatus or drop boxes 110, system 100, or individual drones 130 may redirect an on-route delivery or an arrived delivery or existing delivery to another available drop box. If delivery becomes impossible at one drop box 110, the drop box 110 may direct drone 130 to re-direct a delivery to the nearest available drop box 110. Non-limiting examples of events preventing package delivery may include but not limited to malfunction, inclement weather, loss of power, loss of connectivity, packages larger than the range of acceptable sizes, a drop box that is full, a drop box that has been reserved, a drop box that is not scheduled to receive deliveries, or any other event(s) rendering the drop box 110 or apparatus unavailable to receive deliveries. The drop box 110 may be unavailable to receive deliveries based on the size of the packages and the reserved volumetric space. That is, the available space of the storage portion 250 of the drop box 110 may be limited based on future delivery information, future pick-up information, or other scheduled events. Volumetric availability may be known, estimated, or a combination of the two. Notifications may be sent to users and/or drones when and if a drop box 110 or an apparatus is not available.

Server Device Components

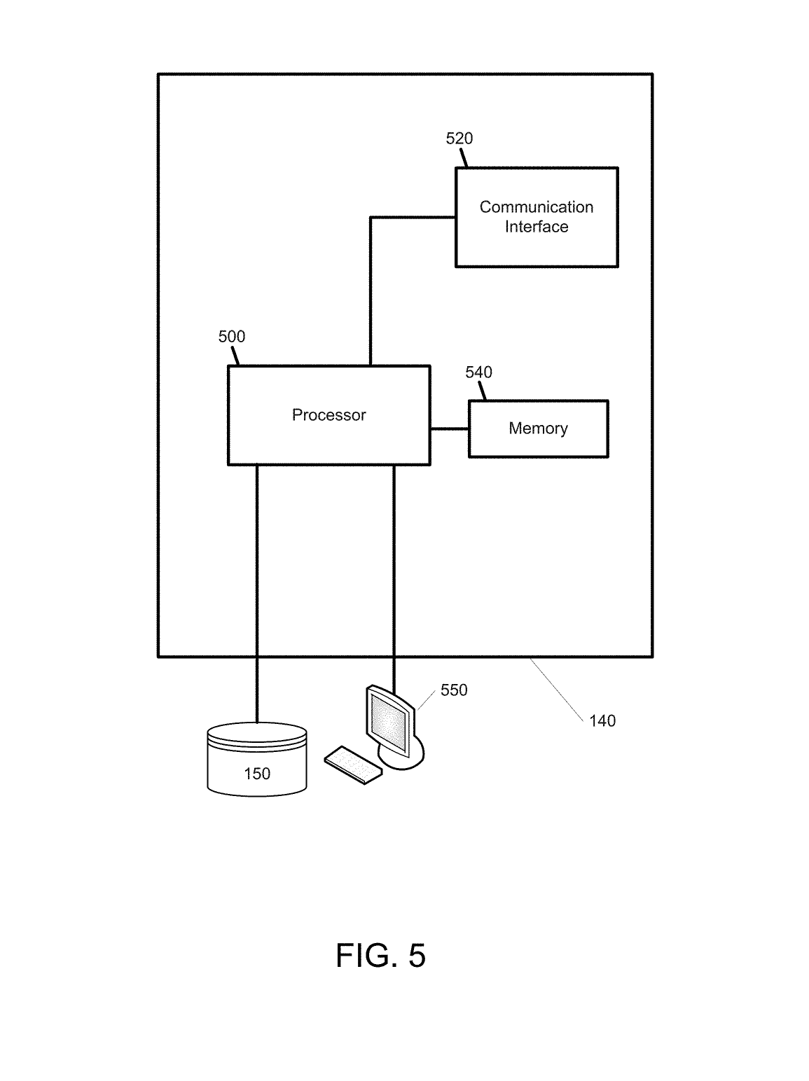

FIG. 5 is a block diagram of an example server 140 of the subject technology of a system 100 for drop box package delivery. An example server 140 may include a processor 500, a communication interface 520, memory 540, a database 150, and one or more workstations 550. Additional, different, or fewer components are possible for the server 140. The server or servers 140 may maintain multiple databases 150. The processor 500 may be configured, connected, and function as described elsewhere in this document.

The one or more servers 140 of the system 100 may be implemented as back end components (e.g., as a data server), middleware components (e.g., an application server), and/or a front end component (e.g., a web browser or client computer with a graphical user interface). The database 150 refers to a set of data stored in one or more storage medium of the system, including the memory 540 of the server or servers 140. Databases may store data associated with delivery, pick-up, senders, recipients, users, location, time schedules, packages, insurance, arrival and departure scans, and the like. Servers, as used herein, may refer collectively to computing devices for creating, maintaining, and updating data associated with described embodiments herein. The one or more workstations 550 may be used to input data associated with the databases 150 or instructions for the one or more processors 500.

Client Device Components

Client device, such as devices 160, 180, may include mobile phones, personal computers, set-top boxes, wireless communication enabled tablets, computers, smart phones, navigation devices, e-readers, and the like. The client devices may be connected wirelessly via the network 120. The client devices may communicate with the drop box 110 or apparatus, individual drone devices 130, the server 140, or other client devices. A user may receive delivery notifications via the client device through a mobile application, an SMS message, image, email, voicemail, through a user account web interface, and the like.

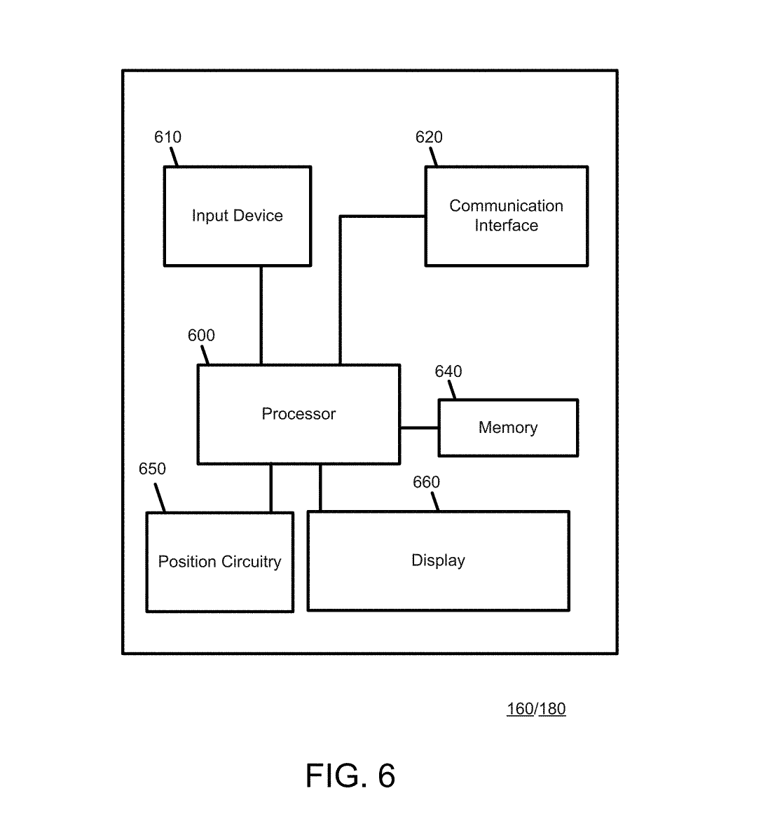

FIG. 6 is a block diagram of an example client device (such as mobile device 160 or personal computer 180) of the subject technology of the system 100 for drop box package delivery. Client devices 160 and/or 180 can include a processor 600, an input device 610, a communication interface 620, memory 640, position circuitry 650, and a display 660. Additional, different, or fewer components are possible for client devices 160 and/or 180 as well as other client devices. The display 660 may include a cathode ray tube (CRT), liquid crystal display (LCD), light emitting diode (LED) monitor or other suitable display technology for displaying received notifications from system 100. The display 660 may provide information to the user using the input device 610. The processor 600 may be configured, connected, and function as described elsewhere in this document

Locations of packages may be determined entirely outside the drop box 110 or apparatus using navigation, delivery and other communication capabilities of the drone 130 and/or by a delivery service connected over the network 120. Passive sensor devices may be included in the drop box 110 to indicate a successful delivery or successful pick-up. Additionally, or alternatively, any client devices connected to or via the network 120 may additionally constitute or be included in the networking system associated with package delivery.

The client devices may include peripheral devices with integrated displays 660 including screens, touchscreens, or other interfaces that may be used as advertising space. For example, a portion of a user's smart phone display may be used to communicate advertising in tandem with delivery messages, identification codes or other interfaces associated with user applications for the delivery system.

Network

Components of the system 100 may be interconnected via one or more networks 120 using one or more mediums or any form of digital data communication. Non-limiting examples of communication networks 120 include cellular networks, WiMAX networks, a local area network (LAN) and a wide area network (WAN), such as the Internet. Components within the system 100 can include multiple clients and servers and multiple client and server instances. A client and server are generally remote, typically interacting through a communication network. The relationship of client and server arises via computer programs running on the respective computers and having a client-server relationship to each other.

The drop box 110 or apparatus or the system 100 can also be hard wired or otherwise constructed to communicate with retailers, consumers, or recipients, and/or drones, and can be configured to receive software updates.

### System Operation

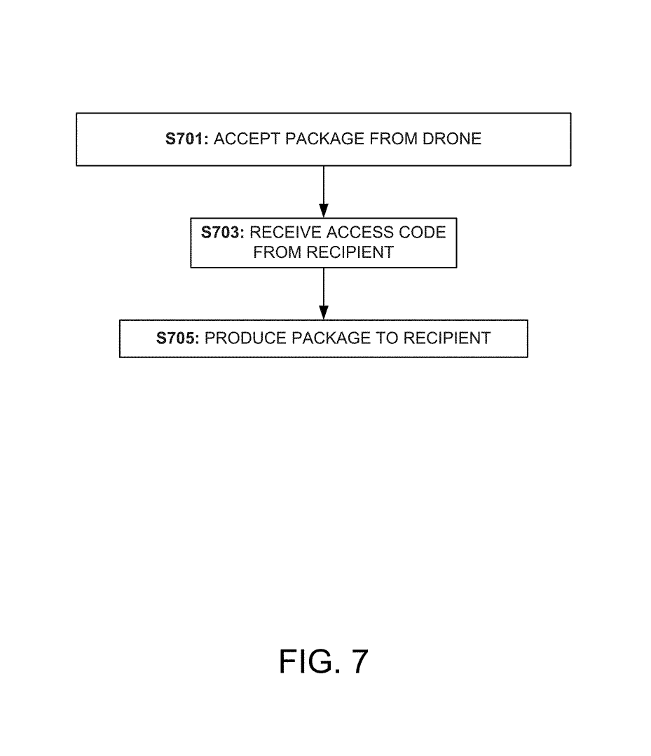

FIG. 7 is a flow diagram of how the system 100 may operate in accordance with one embodiment of the subject technology for drop box package delivery. Acts are described with reference to the system 100 and components depicted in FIGS. 1-6. Additional, different, or fewer acts may be provided. Acts may be performed in orders other than those presented herein.

In an act 5701, at least one package 105 is accepted from an unmanned vehicle via a drop-off opening 210 of a drop box 110 or apparatus. The system 100 may cause the drop box 110 or apparatus to open or unlock a covering or door of the drop-off opening 210 based on the arrival of an unmanned vehicle 130. The system 100 may send a notification to the recipient indicative of the arrival of the at least one package. The system 100 may alternatively, or additionally, send a notification to a sender associated with the at least one package.

In an act S703, an access code, input by a user, is received. The access code identifies the user as a recipient of the at least one package.

In an act S705, the at least one package is produced to a pick-up opening 220 of the drop box 110 or apparatus, whereat the least one package accessible to the recipient.

In some embodiments, the system 100 may receive a request from a user to transfer a previously delivered package from the drop box 110 or apparatus to an alternate location. The system 100 can then send a request for an available unmanned vehicle 130 to relocate the at least one package to the alternate location. The package may be provided to the available unmanned vehicle 130 via the drop-off opening 210 of the drop box 110 or apparatus. A notification may be sent to the user indicating the departure of the unmanned vehicle 130 with the at least one package. The system 100 may receive an indication that the package has arrived at the alternate location and a notification to the user may then be sent indicating the arrival of the package at the alternate location. The user notification may include an access code for the recipient for use at the alternate location to retrieve the package.

In some examples, the drop box 110 or apparatus may act as a return package system. A user may place a return package so that it is received by the drop box 110 and/or may be accessible through the drop box 110 via a drone 130 for return delivery. The return package may be placed into a portion of the drop box 110, on top of the drop box housing, or the like. The drone 130 may pick up and transport the return package back to a retailer, distributor, or other user.

Messages signaling the completed delivery to the drop box 10 or apparatus may be sent to the customer, user or intended recipient via message to their client device, i.e., their mobile device, smart phone, computer, web-based application, or other notification.

### Personalization

In some embodiments, the user may be able to personalize delivery services provided by the drop box 110 and/or the system 100. Personalization may include a user profile, may be associated with preferences for other shipping companies, may be specified by each delivery, may be set before or during delivery, or the like. The user may specify a location for a specific delivery. The user may specify a preferred delivery location. The user may specify a preferred delivery location for types of packages based on the item ordered (for example, for work or for home) or an expected time of delivery (at work during an individual's work hours or home).

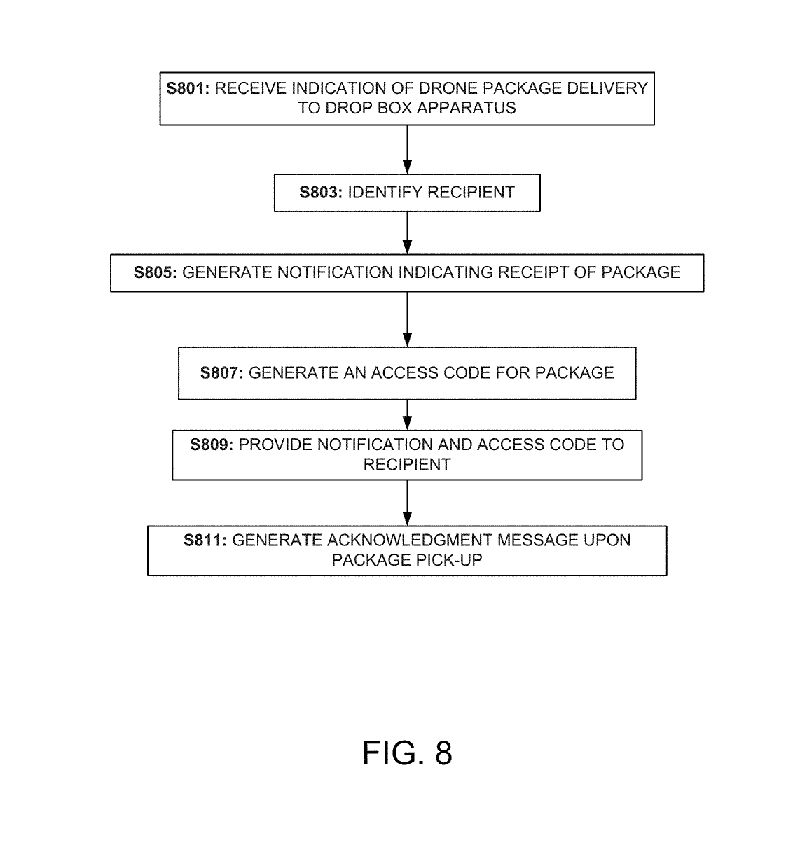

FIG. 8 is a flow diagram in accordance with one embodiment of a method of unattended package delivery in accordance with the subject technology of the system 100. Acts are described with reference to the system 100 and components depicted in FIGS. 1-6. Additional, different, or fewer acts may be provided. Acts may be performed in orders other than those presented herein.

In act S801, an indication is received that a package 105 has been delivered to a drop box 110 or apparatus via an unmanned vehicle 130.

In act S803, a recipient of the package is identified.

In act S805, a notification is generated indicating receipt of the package by the drop box 110 or apparatus. One or more subdivided storage areas of the drop box 110 or apparatus associated with the package may be identified.

In act S807, an access code associated with the package is generated.

In S809, the notification and the access code are provided to a client device for display. The user of the client device is associated with the recipient of the package. The notification may further include an indication of which subdivided storage area of the drop box 100 or apparatus is associated with the package.

Once the user has arrived at the drop box 110 or apparatus, access may be provided to the associated subdivided storage area upon receiving the access code via a graphical user interface of the drop box apparatus.

In act S811, an acknowledgment message is generated upon pick-up of the package by the recipient via the drop box 110 or apparatus.

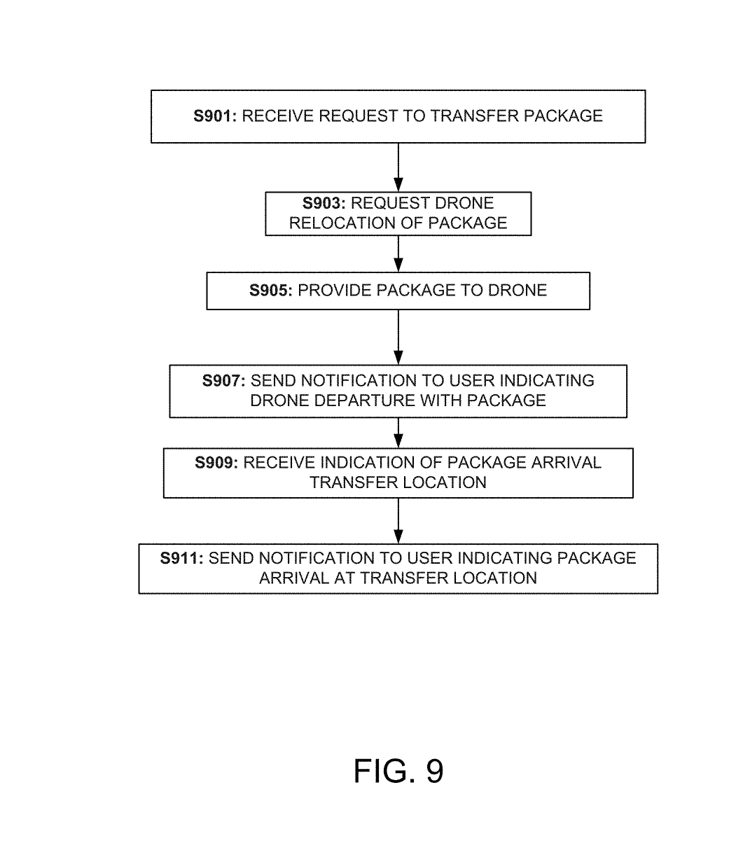

FIG. 9 is a flow diagram in accordance with one embodiment of a method of unattended package delivery in accordance with the subject technology of the system 100. Acts are described with reference to the system 100 and components depicted in FIGS. 1-6. Additional, different, or fewer acts may be provided. Acts may be performed in orders other than those presented herein.

In act 901, a request is received from the identified recipient to transfer the at least one package 105 from the drop box 110 or apparatus to an alternate location.

In act 5903, a request is sent for an available unmanned vehicle 130 to relocate the package to the alternate location.

In act S905, the at least one package is provided to the available unmanned vehicle 130 via the drop-off opening 210 of the drop box 110 or apparatus.

In act S907, a transfer notification is sent to the user indicating the departure of the unmanned vehicle 130 with the at least one package.

In act S909 a transferred delivery notification is received indicating the arrival of the at least one package at the alternate location.

In act S911, a transfer pick-up notification is sent to the user indicating the arrival of the at least one package at the alternate location based on the transferred delivery notification.

Personalization may further be specified as no delivery on certain days or for a period of time (such as while a user is out of town). The user may specify a set of preferred locations based on proximity to home or work or along a frequently traveled route. A delivery may then be sent to the highest preferred delivery location. The determination of which preferred delivery location may be further based on or limited by the size of the package, delivery timing (the user may specify faster delivery at less preferred locations). Alternatively, or additionally, at the point of sale, upon delivery, or upon notification by a delivery service, the user may be provided with a list of available delivery locations and times and the user may select his preferred location and time.

The user may receive a notification that a package has been delivered at a specific drop box location and request that the delivery be re-routed to a different drop box. This may occur after delivery, before delivery, after shipping but before delivery, and the like. Rerouting may include additional charges or convenience fees associated with a rerouted box. Such additional charges may be indicated to the user via a client device, the drop box display, or the like. After shipping, a user may be able to request delayed receipt of a package. Based on the current location of the package some changes in delivery location or timing may not be possible or may require additional drone pick-ups and drop-offs and may be associated with increased delivery fees.

The user may enter and save delivery preferences as part of a user profile accessed via a web browser, mobile application, or other program. The user profile may be linked are associated with other user profiles of delivery services, merchants, social networks, and the like. The user may be able to change his preferences for delivery via drone the drop box without affecting delivery for other services or other methods. The user may be able to select drop box delivery as a form of delivery while an intermediate courier (e.g., third delivery service) is automatically selected by a merchant. Drop box delivery may be specified at the merchant level, and the user may be notified of the drop-off location as a portion of the conclusion of a transaction.

Packages with special delivery requirements (e.g., such as larger odd sizes, refrigeration requirements, humidification limitations, temperature extremes, or other special needs associated with pick-up or delivery conditions may limit drop box availability and timing. Special delivery requirements may be weighted more heavily than user default settings by computer programs scheduling package delivery and timing. The user may set preferences or absolute limitations for personal ease of access or individual needs. For example, packages weighing over a user selected threshold may have delivery limited to a specific location. This way, a user may ensure the user can carry or transport the package to its final destination. Weight based limitations may also be set by the user based on a particular layout or accessibility of the user's nearby drop boxes. For example, a user may specify drop box locations or particular chutes or retrieval locations so that a heavy package may be easily transferred to a vehicle or a dolly, or may limit the amount of lifting required by the user accepting the package. To facilitate ease of access, the user may specify that packages over a specific size or specific weight may be delivered only to the drop box associated with the user's apartment complex or other home or work location so as to minimize the distance that a heavy package must be carried. Such preferences may also be set to aid in convenience based on package size package weight package contents, intended destination, and the like.

### Users

A user of the drop box 110 or apparatus may refer to the individual or entity receiving delivery (e.g., or an addressee) in-person via the drop box at the user pick-up openings 220. Users may also include individuals, entities, delivery services, larger shipping systems such as third-party courier services or sellers using drone delivery to complete deliveries and accept pick-up requests via the drop box at drone drop-off openings. User preferences may establish sets of preferences and limitations associated with the cost of shipping, timing of delivery, timing of pick-up, route details, preferred third-party delivery couriers, and other details associated with sending a package or making a purchase. The user may select one or more user profiles or setting as a default or group of settings.

A user may impose limitations on the types of packages or delivery items that will be delivered at specific drop box locations (e.g. individual drop boxes near a home or office of a user). User-imposed limitations may be applied to delivery scheduling in addition to limitations set by the drop box or an intermediate delivery service. For example, one drop box location may require or limit the type of permitted delivery items, shape, size, weights of items for returns (e.g., purchase exchange or refund of a package or item). System, drone, drop box, or delivery service imposed limitations may be provided to the user in the course of preparing a shipping label from a client device, posted on a drop box housing or provided through graphical user interface prompts at individual drop box locations, or some combination thereof. The user pick-up opening of the drop box may include sensors to enforce drop-off or pick-up limitations. If a weight threshold has been exceeded the user initiated pick-up request, the user may not be permitted to complete the drop-off. An error or refusal notification may be displayed or transmitted, providing another drop box location to complete the pick-up request. Package size, dimension, or volume may be limited by the size, shape, or dimensions of an aperture of a drop-off opening or pick-up opening.

### Security

Security of packages may be provided by a configuration of limited access openings, internal paths, and storage cavities in the drop box, apparatus, and/or housing. Materials may be selected to deter theft and tampering. Construction of cavity dimensions and paths may sort and/or separate packages preventing errors in package distribution to recipients.

In some embodiments, the drop box may include one or more secure retrieval areas that can only be accessed by the recipient or with recipient specific information. A recipient may have a personalized or customized code associated with a secure retrieval area that may be set mechanically or electronically. For example, a physical lock and key or combination lock may be used for user rental, reservation, or purchase of an entire drop box, drop-off opening, or pick-up opening. Digitally reprogrammable keypad locks may secure package pick-up and be changed remotely via server.

Unique, single use codes generated by the drop box, user selected passwords, barcode scanning, biometric sensing, or the like may be incorporated to ensure secure delivery. The apparatus may determine a unique identification code or security code based on the portion of the receptacle in which a package is delivered. Unique identification codes may be transmitted to the user contemporaneously with the notification indicating that a package has arrived at the receptacle. This unique identification code may be a one-time use code and may include one or more randomly generated alphanumeric characters. Recipient users may receive a notification including unique passcode, barcode, or other wirelessly transmitted passkey information. Users may be prompted via the drop box graphical user interface to present a barcode or enter an electronic code to complete package retrieval from the drobox. A prompt may be provided for a user to input biometric information such as a fingerprint on an appropriate scanner of the drop box. Presentation or entry of an electronic code or other access code may replace the need for a recipient signature. Recipient signatures may also be provided via a touchscreen at drop box pick-up.

A camera 234 may be used to capture images displaying a passcode, barcode, or other image based code for secure transmission of a network. One example is transmission of a QR code (e.g., airline boarding pass reader-type systems) or image of a QR code generated upon confirmation of receipt of a package at a drop box and transmitted to the user via email.

Users may reserve or rent a particular retrieval area for a length of time, and may optionally set a repeat use passcode or combination for access to a pick-up opening for the duration of the reservation window or rental. Reservations and rentals may be used to guarantee exclusive access or to guarantee delivery at specific drop box locations and times. Client device identification and/or proximity of the client device to the drop box may be required for secure access to delivered packages.

Cameras and sensors may be dedicated to or capturing image data, sound, or other information to create a record of drone information and/or when users retrieve a stored package. In one example, a motion sensor or touch sensor may initiate and terminate data capture. Still or moving images, sound or other recorded information may be transmitted to a user automatically or upon request. Recorded information may be stored locally on the apparatus or may be transmitted to a server or client device on-demand, or through batch processing at regular intervals. Captured images may be associated with identification information of the intended recipient, or identification information associated with the delivered package. Accordingly, if an unauthorized or unintended recipient takes possession of the delivery, a record of the event may be available. Camera feeds may be wirelessly available to merchants and/or clients and communicated wirelessly over a network.

Other security measures may include temperature sensors, movement sensors, and/or smoke detectors inside storage areas, paths or other internal areas of the drop box. Drop-off openings and pick-up openings may be sealed shut upon smoke detection to extinguish a fire inside the drop box. Sensors may be used to anticipate packages that may contain hazardous material, and the drop box may be configured to refuse acceptance of a suspicious package. Additional safety protocols include unmanned vehicle removal of dangerous packages from a drop box.

As noted above, the drop box can be a stand-alone drop box with a distinct housing and footprint that resides next to a building or other structure, whether in or protected from the elements. The drop box, e.g. an apparatus as used above, can also be integrated into a building or structure with no discernable housing or footprint. The drop-off opening can be provided in a structure roof and can lead into a chute or chutes that direct packages to one or more storage areas created separately within the building or structure. Likewise, the pick-up openings can directly open into the one or more storage areas or can be connected thereto via additional chutes or paths. Thus, the pick-up openings can be distant and separate from the storage areas and distinct and independent therefrom.

The term “computer-readable medium” includes a single medium or multiple media such as memory, a centralized or distributed database, and/or associated caches and servers that store one or more sets of instructions in accordance with some embodiments for drop box package delivery systems, apparatus, or methods. The term “computer-readable medium” includes any medium capable of storing, encoding, or carrying a set of instructions, such as computer program code for one or more programs. Instructions, such as computer program code stored on computer-readable medium for execution by a processor or that cause a computer system to perform any one or more of the methods or operations disclosed herein. Computer-readable medium includes solid-state memory such as a memory card device including one or more non-volatile read-only data. Computer-readable medium further volatile re-writable memory such as random access memory. Computer-readable medium includes magneto-optical or optical mediums to capture carrier wave signals such as a signal communicated over a transmission medium. A digital file attachment or other self-contained data set may be considered a distribution medium that is a tangible storage medium. Accordingly, the disclosed system 100 and components thereof are considered to include any one or more of a computer-readable medium, distribution medium and other equivalents, and future media types. These examples may be collectively referred to as a non-transitory computer-readable medium.

The methods, operations, acts, and logic flows as described herein may be performed by one or more programmable processors executing one or more computer programs or may also be partially or completely implemented as special purpose logic circuitry (e.g., an FPGA or an ASIC). Processors as referred to herein include both general and special purpose microprocessors as well as any one or more processors of any kind of digital computer.

Illustrations, including figures, of the embodiments described herein are intended to provide a general understanding of the structure of various embodiments. Illustration is not intended to serve as a complete description of all the elements and features of apparatus, systems, and methods using the structures and methods described herein. Illustration is merely representational and figures may not be drawn to scale. Certain proportions within the illustrations may be exaggerated, while other proportions may be minimized. Portions of interior and exterior views of components may not be physically viewable from a single view as illustrated. Such incomplete, partial, or combinations of views and are provided for context. Thus, the disclosure and the figures are to be regarded as illustrative rather than restrictive.

Examples and embodiments should not be construed as limitations on the scope of the invention or what may be claimed, rather as descriptions of features specific to particular embodiments of the invention. Certain features that are described herein in the context of separate embodiments can also be implemented in combination in a single embodiment. Conversely, various features that are described in the context of a single embodiment can also be implemented in multiple embodiments separately or in any suitable sub-combination. Although features may be described as acting in certain combinations and even initially claims as such, one or more features from a claimed combination, can, in some cases, be excised from the combination, and the claimed combination may be directed to a sub-combination or variations of a sub-combination.

Although certain delivery drop box systems, apparatus, DDS devices, components, features, advantages, methods, and the like have been described herein in accordance with the teachings of the present disclosure, the scope of coverage of this patent is not limited thereto. On the contrary, this patent covers all embodiments of the teachings of the disclosure that fairly fall within the scope of permissible equivalents.

I claim:

1. A drop box apparatus, the drop box apparatus comprising:
a defined cavity capable of storing packages;
a drop-off opening disposed and arranged to receive at least one package via an unmanned vehicle;
a pick-up opening disposed and arranged to provide access to the at least one package via a recipient; and
at least one path connecting the defined cavity, the drop-off opening, and the pick-up opening.

2. The drop box apparatus of claim 1, wherein the drop-off opening is disposed and arranged to receive at least one package via an unmanned aerial vehicle or an unmanned ground vehicle.

3. The drop box apparatus of claim 1,
wherein the pick-up opening is further disposed and arranged to receive at least one outgoing package from a user, and
wherein the drop-off opening is further disposed and arrange to provide access to the at least one outgoing package via a recipient.

4. The drop box apparatus of claim 1, further comprising:
a sorting mechanism directing received packages from the drop-off opening to a plurality of subdivided storage areas.

5. The drop box apparatus of claim 4, wherein the pick-up opening is connected with each of the subdivided storage areas so as to provide access to each of the subdivided storage areas.

6. The drop box apparatus of claim 5, wherein the pick-up opening comprises a plurality of pick-up openings, each respective pick-up opening in connection with one of the plurality of subdivided storage areas.

7. The drop box apparatus of claim 1, further comprising:
a selection mechanism directing received packages to the pick-up opening.

8. The drop box apparatus of claim 1, further comprising:
a security device limiting access to the pick-up opening.

9. A system for drop box package delivery, the system comprising:
a drop box apparatus;
a processor associated with the drop box apparatus; and
at least one memory including computer program code for one or more programs; the at least one memory and the computer program code configured to, with the at least one processor, cause the drop box apparatus to:
accept at least one package from an unmanned vehicle via a drop-off opening of the drop box apparatus;
receive an access code input by a user, wherein the access code identifies the user as a recipient of the at least one package; and
produce the at least one package at a pick-up opening of the drop box apparatus, whereat the at least one package is accessible to the recipient.

10. The system of claim 9, wherein the at least one memory and the computer program code are configured to, with the at least one processor, cause the system to:
open a covering of the drop-off opening based on the arrival of an unmanned aerial vehicle or an unmanned ground vehicle.

11. The system of claim 9, wherein the at least one memory and the computer program code are configured to, with the at least one processor, cause the system to:
send a notification to the recipient indicative of the arrival of the at least one package.

12. The system of claim 9, wherein the at least one memory and the computer program code are configured to, with the at least one processor, cause the system to:
send a notification to a sender associated with the at least one package.

13. The system of claim 9, wherein the at least one memory and the computer program code are configured to, with the at least one processor, cause the system to:
receive a request from a user to transfer the at least one package from the drop box apparatus to an alternate location;
request an available unmanned vehicle to relocate the at least one package to the alternate location;
provide the at least one package to the available unmanned vehicle via the drop-off opening of the drop box apparatus; and
send a notification to the user indicating the departure of the unmanned vehicle with the at least one package.

14. The system of claim 13, wherein the at least one memory and the computer program code are configured to, with the at least one processor, cause the system to:
receive an indication that the at least one package has arrived at the alternate location; and
send a notification to the user indicating the arrival of the at least one package at the alternate location.

15. The system of claim 14, wherein the at least one memory and the computer program code are configured to, with the at least one processor, cause the system to:
provide an access code to the user identifying the user as a recipient of the at least one package at the alternate location.

16. A method of unattended package delivery, the method comprising:
receiving an indication that a package has been delivered to a drop box apparatus via an unmanned vehicle;
identifying a recipient of the package;
generating a notification indicating receipt of the package by the drop box apparatus;
generating an access code associated with the package;
providing the notification and the access code for display to a client device associated with the recipient of the package; and
generating an acknowledgment message upon pick-up of the package by the recipient via the drop box apparatus.

17. The method of claim 16, further comprising:
associating one of a plurality of subdivided storage areas with the received package; and
providing access to the associated subdivided storage area upon receiving of the access code via a graphical user interface of the drop box apparatus.

18. The method of claim 17, wherein the notification further comprises an identification of the subdivided storage area associated with the package.

19. The method of claim 16, further comprising:
receiving a request from the identified recipient to transfer the at least one package from the drop box apparatus to an alternate location;
sending a request for an available unmanned aerial vehicle or unmanned ground vehicle to relocate the package to the alternate location;
providing the at least one package to the available unmanned aerial vehicle or the available unmanned ground vehicle via the drop-off opening of the drop box apparatus; and
sending a transfer notification to the user indicating the departure of the unmanned aerial vehicle or unmanned ground vehicle with the at least one package.

20. The method of claim 19, further comprising:
receiving, by the drop box apparatus, a transferred delivery notification upon the arrival of the at least one package at the alternate location; and
sending a transfer pick-up notification to the user indicating the arrival of the at least one package at the alternate location based on the transferred delivery notification.
